(19) United States
(12) Patent Application Publication
(10) Pub. No.: US 2010/0179282 A1
(43) Pub. Date: Jul. 15, 2010

(54) POLYESTERS CONTAINING AMINO GROUPS

(75) Inventor: Emmanouil Spyrou, Schermbeck (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa GmbH, Essen (DE)

(21) Appl. No.: 12/601,835

(22) PCT Filed: May 16, 2008
(86) PCT No.: PCT/EP08/56034

§ 371 Date: Nov. 25, 2009

(30) Foreign Application Priority Data
Jul. 2, 2007 (DE) 102007030669.7

(51) Int. Cl. C08L 79/00; C08F 20/00

(52) U.S. Cl. 524/602; 525/437

(57) ABSTRACT

The present invention relates to polyesters which have been modified with one or more polyamines having at least one primary and at least one secondary amino group, to processes for preparing them and to their use.

The present invention relates to polyesters which have been modified with one or more polyamines having at least one primary and at least one secondary amino group, to processes for preparing them and to their use.

Polyesters are a widespread and much-used class of polymer whose properties and preparation processes have been documented in numerous texts. The reaction of polyesters or their starting materials with amines is likewise known.

U.S. Pat. No. 5,672,676 describes the reaction of dicarboxylic acids, dialcohols and diamines in the melt. However, it uses only primary amines and there are no amines detectable in the end product.

WO 2003/078502 describes the reaction of polyesters with nitrogen components, amines for example. The reaction in question involves the modification of thermoplastic polyesters in order thus to influence the crystallization temperature and rheology. Analysis shows the ethylenediamine used in the examples to be fully incorporated as an amide. In the end product, therefore, there are no free amines.

U.S. Pat. No. 4,604,449 describes the aminolysis of polyesters. It uses primary diamines or amino alcohols. Free amino groups remaining, or the extent of the storage stability, is not mentioned there.

Amine-terminated polyesters have been described as well. U.S. Pat. No. 5,525,683 provides hydroxy-functional polyesters with a leaving group and then reacts them with an amino alcohol. This produces ether-bridged, amine-terminated polyesters. This procedure is highly complicated, and, moreover, the storage stability of the end products is neither mentioned nor measured.

DE 4244030 describes the addition of ammonia or amines to olefinically unsaturated structural units of polyesters. This process, however, is limited to those polyesters which actually have these unsaturated units.

Although amine-terminated polyesters are useful ingredients of coating, adhesive and printing ink formulations, they are generally not without drawbacks. The first drawback lies in the preparation, where high temperatures lead to instances of discoloration. The second drawback is in the limited storage stability of such products since free amine groups tend to attack remaining ester groups and this amidation releases alcohols.

It was an objective of the present invention, therefore, to prepare amine-terminated polyesters which not only are low in yellowing but also, furthermore, are storage-stable.

Surprisingly it has been found that polyesters can be reacted with polyamines which contain at least one primary and one secondary amino group. If the temperature is kept at a moderate level, neither the colour nor the storage stability suffers.

The present invention accordingly first provides polyesters modified with one or more polyamines having at least one primary and at least one secondary amino group. In the polyester there are preferably at least two ester groups per primary amino group of the polyamine.

As compared with the prior-art polyesters, the polyesters of the invention have the substantial advantage that they are storage-stable. Storage-stable products are those which after 28 days at 40° C. differ by no more than 20% from the initial level of titrimetrically detectable amines. Furthermore, the polyesters of the invention are also storage-stable in colour terms. Products storage-stable in colour terms are those which have a yellowish colour but have not suffered brown or even black discoloration.

The polyesters of the invention are obtainable by reacting a polyester with one or more polyamines having at least one primary and at least one secondary amino group. In accordance with the invention the reaction takes place with particular preference at a temperature of 20-200° C. This reaction takes place within a period from 1 minute to 4 weeks. The objective of the reaction regime is the virtually complete reaction of the primary amino groups with the polyester, but with the secondary amino groups having undergone almost no reaction at all with the polyester. Overall it is preferable to ensure that the ratio of polyester to polyamine is selected such that there are at least two ester groups of the polyester to one primary amine group of the polyamine.

The polyesters used in accordance with the invention are obtainable by polycondensing one or more dicarboxylic acids and one or more diols and/or polyols. The condensation takes place in a conventional manner in an inert-gas atmosphere at temperatures from 100 to 260° C., preferably 130 to 220° C., in the melt or in an azeotropic procedure, as described for example, in Methoden der Organischen Chemie (Houben-Weyl); Volume 14/2, pages 1 to 5, 21 to 23, 40 to 44, Georg Thieme Verlag, Stuttgart, 1963, or in C. R. Martens, Alkyd Resins, pages 51 to 59, Reinhold Plastics Appl. Series, Reinhold Publishing Comp., New York, 1961.

The dicarboxylic acids that are preferred for the preparation of polyesters may be aliphatic, cycloaliphatic, aromatic and/or heterocyclic in nature. Furthermore, the dicarboxylic acids may, if desired, be substituted by halogen atoms and/or unsaturated. Examples of suitable dicarboxylic acids include succinic, adipic, suberic, azelaic, sebacic, phthalic, terephthalic, isophthalic, trimellitic, pyromellitic, tetrahydrophthalic, hexahydrophthalic, hexahydroterephthalic, dichlorophthalic, tetrachlorophthalic, endomethylenetetrahydrophthalic, glutaric and 1,4-cyclohexanedicarboxylic acid and/or—where available—their anhydrides or esters.

The diols and/or polyols may be selected, for example, from the group consisting of monoethylene glycol, 1,2- and 1,3-propylene glycol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2,6}]decane (Dicidol), 1,4-bis(hydroxymethyl)cyclohexane, 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4(2,4,4)-trimethylhexane-1,6-diol, glycerol, trimethylolpropane, trimethylolethane, hexane-1,2,6-triol, butane-1,2,4-triol, tris(β-hydroxyethyl) isocyanurate, pentaerythritol, mannitol and sorbitol and also diethylene glycol, triethylene glycol, tetraethylene glycol, dipropylene glycol, polypropylene glycols, polybutylene glycols, xylylene glycol and neopentyl glycol hydroxypivalate.

Preference is given to using hydroxy-functional polyesters having an OH number from 1 to 400 mg KOH/g, more preferably 5 to 150. The hydroxyl number is determined in accordance with DIN 53240-2.

In that method the sample is reacted with acetic anhydride in the presence of 4-dimethylaminopyridine as catalyst and the hydroxyl groups are acetylated. One molecule of acetic acid is formed per hydroxyl group, while the subsequent hydrolysis of the excess acetic anhydride yields two molecules of acetic acid. The consumption of acetic acid is determined titrimetrically from the difference between the main value and a blank value which is carried out in parallel.

What is essential for the present invention is that the abovementioned polyesters have been modified with polyamines containing at least one primary and at least one secondary amino group. Suitable in principle as polyamines for use in accordance with the invention are all polyamines which meet these conditions. These polyamines may be aliphatic, cycloaliphatic, aromatic and/or heterocyclic; more particularly they are aliphatic and/or cycloaliphatic. The polyamine is selected more particularly from the group consisting of N-methylethylenediamine, N-ethylethylenediamine, N-propylethylenediamine, N-butylethylenediamine, N-benzylethylenediamine, N-phenylethylenediamine, N-methylpropylenediamine, N-ethylpropylenediamine, N-propylpropylenediamine, N-butylpropylenediamine, N-benzylpropylenediamine, N-phenylpropylenediamine, N-hydroxyethylethylenediamine, diethylenetriamine, triethylenetetramine, pentaethylenehexamine, bishexamethylenetriamine, N-cyclohexylpropylenediamine and N-[3-(tridecyloxy)propyl]-1,3-propanediamine Adogen 583).

The preferred amine-modified end products have an amine number from 5 to 100 and an OH number from 6 to 155 mg KOH/g. Particular preference is given to an amine number from 10 to 50 and an OH number from 11 to 101. The amine number is determined by titration with 1N hydrochloric acid using bromophenol blue.

Likewise provided by the present invention are processes for preparing the polyesters of the invention that comprise reacting a polyester with one or more polyamines having at least one primary and at least one secondary amino group. The reaction takes place more particularly at a temperature of 20-200° C. The reaction may also take place within a period from 1 minute up to 4 weeks. Preferably the reaction takes place at a temperature of 80-140° C. in a reaction time from 5 minutes up to 5 hours. With particular preference the reaction takes place over a period from 10 minutes to 3 hours at a temperature of 90-130° C.

In one embodiment of the present invention, the polyester can be reacted with the one or more polyamines without the addition of a solvent. In that case the reaction takes place preferably in the melt. Typically here the polyester is melted and reacted with the one or more polyamines. This reaction preferably takes place under protective gas, nitrogen or argon for example, more particularly under nitrogen.

In one alternative embodiment of the present invention the reaction takes place in the presence of a solvent. The solvent is selected more particularly from the group consisting of benzene, toluene, mixtures of aromatics (commercial designation: Solvesso) and other typical paint solvents.

Examples of suitable assemblies for the reaction include heatable stirred tanks, kneading devices or else extruders. Not only the starting products but also the end product of the invention may be solid or liquid. The reaction temperature output preferably to be selected such that all of the constituents are present in liquid form in the same phase.

The reaction is guided in such a way that the more reactive primary amino groups are consumed by reaction, but not the less reactive secondary amino groups. The end point is reached when the amount of titrimetrically detectable amino groups is not more than 20% different from the arithmetic level of secondary amino groups.

The present invention further provides for the use of the polyesters of the invention in coatings, more particularly in thermosetting 1K or 2K (1-component or 2-component) formulations, for coil coating, can coating, industrial coatings, architectural preservation, woodblock floor coatings and automotive finishes, for example, but also for adhesives applications, more particularly reactive adhesive systems.

Coatings comprising polyesters of the invention are likewise provided by the present invention.

Even without further remarks it is assumed that a person skilled in the art will be able to utilize the above description to its widest extent. Consequently, the preferred embodiments and examples are to be interpreted solely as a descriptive disclosure which in no way has any limiting effect.

The present invention is illustrated below with reference to examples. Alternative embodiments of the present invention are obtainable analogously.

### EXAMPLES

| Ingredients | Product description, manufacturer |
|---|---|
| Dynacoll 7390 | Hydroxyl-containing polyester resin, |
| | Degussa GmbH, Coatings & Colorants, OH |
| | number 30 mg KOH/g, m.p. 110° C. |
| Oxyester T1136 | Hydroxyl-containing polyester resin, |
| | Degussa GmbH, Coatings & Colorants, OH |
| | number 107 mg KOH/g |
| Dynapol L 411 | Hydroxyl-containing polyester resin, |
| | Degussa GmbH, Coatings & Colorants, OH |
| | number 5-10 mg KOH/g, m.p. 110° C. |
| DETA | Diethylenetriamine, Aldrich |
| HA200ND | Aromatics mixture with low naphthalene |
| | content, solvent, DHC Solvent Chemie GmbH |

### Example 1

90 g of Dynacoll 7390 are melted at 110° C. and 10 g of DETA are added under nitrogen. After 10 minutes of intense stirring the mixture is cooled and the amine number is measured (titrimetrically with 1 N HCl using bromophenol blue). The amine number has fallen from an initial 163 to 55 mg KOH/g (arithmetically, in the case of one remaining amino group, there ought to be a residual amine number of 57 mg KOH/g). To determine the storage stability the product is kept at 40° C. for 4 weeks and the amine number is measured again. After this time it is 54 mg KOH/g. The product has undergone slight yellowish discoloration.

### Example 2

90 g of Oxyester T1136 are heated to 110° C. and 10 g of DETA are added under nitrogen. After 60 minutes of intense stirring the mixture is cooled and the amine number is measured (titrimetrically with 1 N HCl using bromophenol blue). The amine number has fallen from an initial 163 to 64 mg KOH/g (arithmetically, in the case of one remaining amino group, there ought to be a residual amine number of 57 mg KOH/g). To determine the storage stability the product is kept at 40° C. for 4 weeks and the amine number is measured again. After this time it is 60 mg KOH/g. The product has undergone slight yellowish discoloration.

### Example 3

97.5 g of Dynapol L 411 are dissolved in 185 g of HA200ND/methoxypropyl acetate (1:1) and heated to 110° C. and 2.5 g of DETA are added under nitrogen. After 180 minutes of intense stirring the mixture is cooled and the amine number is measured (titrimetrically with 1 N HCl using bromophenol blue). The amine number has fallen from an initial 33 to 12 mg KOH/g (arithmetically, in the case of one remaining amino group, there ought to be a residual amine number of 13.5 mg KOH/g). To determine the storage stability the product is kept at 40° C. for 4 weeks and the amine number is measured again. After 4 weeks it is still 12 mg KOH/g.

All amine numbers in this example have been extrapolated to 100% solids. The product has undergone yellowish discoloration.

1. A polyester that has been modified with one or more polyamines having at least one primary and at least one secondary amino group.

2. The polyester according to claim 1, wherein the polyester comprises at least two ester groups per primary amino group of the polyamine.

3. The polyester according to claim 1, wherein the polyester is storage-stable.

4. The polyester according to claim 1, wherein the fraction of titrimetrically detectable amino groups after 28 days at 40° C. differs by not more than 20% from the original fraction.

5. The polyester according to claim 1, obtainable by reacting a polyester with one or more polyamines having at least one primary and at least one secondary amino group.

6. The polyester according to claim 1, wherein said polyester is obtainable by polycondensing one more dicarboxylic acids and one or more diols and/or polyols.

7. The polyester according to claim 1, wherein the polyamine is aliphatic, cycloaliphatic, aromatic and/or heterocyclic.

8. A process for preparing a polyester according to claim 1, that comprises reacting a polyester with one or more polyamines having at least one primary and at least one secondary amino group.

9. The process according to claim 8, wherein the reaction takes place at a temperature of 20-200° C.

10. The process according to claim 8, wherein the reaction takes place within a period from 1 minute up to 4 weeks.

11. The process according to claim 8, wherein the reaction takes place without the addition of a solvent.

12. The process according to claim 8, wherein the reaction takes place in the melt.

13. The process according to one claim 8, wherein the reaction takes place in the presence of a solvent.

14. The use of a polyester according to claim 1 in a coating.

15. A coating comprising a polyester according to claim 1.

16. A process of thermosetting comprising coating a formulation with the polyester according to claim 1.
